(19) United States
(12) Patent Application Publication
(10) Pub. No.: US 2021/0194557 A1
(43) Pub. Date: Jun. 24, 2021

(54) Accurate Sidelink CSI Report

(71) Applicant: MediaTek Singapore Pte. Ltd., Singapore (SG)

(72) Inventors: Xuelong Wang, Beijing (CN); Tao Chen, Beijing (CN); Guan-Yu Lin, Hsin-Chu (TW); Ming-Yuan Cheng, Hsin-Chu (TW)

(21) Appl. No.: 17/125,390

(22) Filed: Dec. 17, 2020

Related U.S. Application Data
(63) Continuation of application No. PCT/CN2019/126162, filed on Dec. 18, 2019.

(30) Foreign Application Priority Data
Dec. 15, 2020 (CN) 202011481175.0

(51) Int. Cl. H04B 7/06; H04B 7/0456; H04W 80/02; H04W 24/10; H04L 1/18; H04L 5/00; H04W 76/27

(52) U.S. Cl. CPC H04B 7/0626; H04B 7/0632; H04B 7/0486; H04W 80/02; H04W 92/18; H04L 1/1819; H04L 5/0055; H04W 76/27; H04W 24/10

(57) ABSTRACT

Apparatus and methods are provided for the UE performs restriction procedures for accurate sidelink CSI report using MAC CE. In one embodiment, the UE stops sending SL CSI if it is larger than the configured delay budget to address the out-of-date issue. In one embodiment, the UE starts a prohibit timer upon transmission of the first SL CSI report and prohibits generating a second SL CSI report on MAC CE before the prohibit timer expires. In another embodiment, the UE prohibits generating of a second SL CSI report before a success transmission of the first SL CSI report. In yet another embodiment, the UE includes in the SL CSI report at least one reference elements comprising a version number of the SL CSI report and a time stamp of the SL CSI report.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2019/126162, titled “Methods and Apparatus Accurate Sidelink CSI Report,” with an international filing date of Dec. 18, 2019. This application claims priority under 35 U.S.C. § 119 from Chinese Application Number CN 202011481175.0, titled “ACCURATE SIDELINK CSI REPORT,” filed on Dec. 15, 2020. The disclosure of each of the foregoing documents is incorporated herein by reference.

### TECHNICAL FIELD

The disclosed embodiments relate generally to wireless communication, and, more particularly, to accurate sidelink CSI report with restriction procedure.

### BACKGROUND

5G radio access technology will be a key component of the modern access network. It will address high traffic growth and increasing demand for high-bandwidth connectivity. In 3GPP New Radio (NR), sidelink continues evolving. With new functionalities supported, the sidelink offers low latency, high reliability and high throughout for device to device communications. NR vehicle to everything (V2X) supports sidelink measurement. In sidelink measurement report, channel quality indication (CQI)/ranking indication (RI) are used for channel state information (CSI) report. Unlike the CSI report for Uu interface, the sidelink CSI report is carried on MAC control element (CE).

Improvements and enhancements are required for measurement configuration and report for sidelink open-loop power control.

### SUMMARY

Apparatus and methods are provided for the UE performs restriction procedures for accurate sidelink CSI report using MAC CE. In one novel aspect, the UE stops sending SL CSI if it is larger than the configured delay budget or a maximum delay to address the out-of-date issue. In one embodiment, the UE establishes a sidelink with a receiving UE in a wireless network, performs SL measurements on the sidelink to obtain an SL CSI information including CQI and/or RI, generates a first SL CSI report based on the SL CSI information using a MAC CE, wherein the first SL CSI report is transmitted or retransmitted when a CSI trigger is detected, and cancels a triggered first SL CSI report transmission when a latency bound associated to the triggered first SL CSI report exceeds a latency threshold. In one embodiment, the latency threshold is a configured delay budget. In another embodiment, the configured delay budget is configured by RRC signaling. In yet another embodiment, the UE subsequently, transmits a second SL CSI report with newly measured CSI information upon completion of the first CSI report transmission.

In one novel aspect, the UE performs restriction procedures to get accurate sidelink CSI report. In one embodiment, the UE establishes a sidelink with a receiving UE in a wireless network, performs SL measurements on the sidelink to obtain an SL CSI including CQI and/or RI, generates a first SL CSI report based on the SL CQI/RI using a MAC CE, wherein the first SL CSI report is transmitted or retransmitted when a CSI trigger is detected, and performs an SL CSI report restriction process such that the receiving UE receives up-to-date CSI report. In one embodiment, the UE starts a prohibit timer upon transmission of the first SL CSI report and prohibits generating a second SL CSI report on MAC CE before the prohibit timer expires. In another embodiment, the UE prepares the second SL CSI report on MAC CE based on latest SL CSI information upon expiration of the prohibiting timer and transmits the second SL CSI report to the receiving UE. In one embodiment, the UE prohibits generating of a second SL CSI report before a success transmission of the first SL CSI report. In another embodiment, the UE prohibits a hybrid automatically retransmission request (HARQ) for the first SL CSI report. In one embodiment, the UE starts a prohibit timer upon transmission of the first SL CSI report and prohibits new data from being delivered to a PHY layer before the prohibit timer expires. In another embodiment, the UE assigns a fix numbered HARQ process to the first SL CSI report and prohibits new data from being delivered to a PHY layer in the fix numbered HARQ before an ACK is received corresponding to the first SL CSI report. In one embodiment, the UE includes in the first SL CSI report at least one reference elements comprising a version number of the first SL CSI report and/or a time stamp of the first SL CSI report.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network for measurement accurate sidelink CSI report with restriction procedure in accordance with embodiments of the current invention.

FIG. 2 illustrates an exemplary NR wireless system with centralized upper layers of the NR radio interface stacks in accordance with embodiments of the current invention.

FIG. 3 illustrated exemplary diagrams for a UE to perform CSI restriction procedures such that the receiving UE receives latest CSI report in order in accordance with embodiments of the current invention.

FIG. 4 illustrates exemplary diagrams of a restriction procedure of the TX UE stopping sending SL CSI when the latency of a successful sending of the CSI report is larger than a configured delay budget or a maximum delay in accordance with embodiments of the current invention.

FIG. 5 illustrates exemplary diagrams of a restriction procedure of the TX UE setting a prohibit timer that keeps the CSI report pending without generating MAC CE for transmission in accordance with embodiments of the current invention.

FIG. 6 illustrates exemplary diagrams of a restriction procedure of the TX UE setting a restriction at the MAC layer for packet data unit (PDU) assembly in accordance with embodiments of the current invention.

FIG. 7 illustrates exemplary diagrams of a restriction procedure of the TX UE setting a restriction of CSI report for HARQ retransmission in accordance with embodiments of the current invention.

FIG. 8 illustrates exemplary diagrams of a restriction procedure of including a version number and/or time stamps for CSI report MAC CE messages in accordance with embodiments of the current invention.

FIG. 9 illustrates exemplary diagrams of a restriction procedure of the TX UE setting prohibit timer with HARQ buffer to prohibit new data being delivered to the PHY layer in accordance with embodiments of the current invention.

FIG. 10 illustrates exemplary diagrams of a restriction procedure of the TX UE setting TB including only CSI report and no mux with SL data in accordance with embodiments of the current invention.

FIG. 11 illustrates an exemplary flow chart of a UE restriction procedure by stopping SL CSI sending when latency is larger than a configured delay budge or a maximum delay in accordance with embodiments of the current invention.

FIG. 12 illustrates an exemplary flow chart of a UE restriction procedure for accurate CSI report for sidelink in accordance with embodiments of the current invention.

### DETAILED DESCRIPTION

Reference will now be made in detail to some embodiments of the invention, examples of which are illustrated in the accompanying drawings.

In an NR wireless network, the sidelink is enabled. NR vehicle to everything (V2X) supports the transmission of CSI-RS for CQI and/or RI measurement. In the following description, CQI/RI is used for simplicity. CSI-RS is confined with physical sidelink shared channel (PSSCH) transmission and it can only be transmitted if SL CQI/RI report is enabled by high layer signaling. The SL CQI/RI report from RX UE is enabled by SCI (i.e. Sidelink Control Information) at physical layer to help the TX UE to do link adaption. The traditional CSI report over Uu is performed at physical layer. In NR V2X, 3GPP agreed to report the SL CSI via MAC CE (with one OCTET) identified by new logic channel identification (LCID). The CSI report event shall be cancelled if the CSI report has been transmitted. The CSI report is one-shot transmission. There is fixed priority for the transmission of SL CSI MAC CE. The prioritization rule for SL data can be reused for SL CSI MAC CE. Since the reception of a particular SL CSI report at the Receiver side may be delayed, or the transmission of a particular SL CSI report is not correctly decoded by the Receiver side (at HARQ combination), which leads to a retransmission of the SL CSI report by HARQ. The sequential SL CSI report organized by MAC will be sent by PHY in a non-sequential manner, and eventually being received by Receiver side out of order. The Receiver side receive CSI report, which is out of date. There will be a risk for the Receiver side to adjust the MCS according to the CSI report, which is out of date. The same applies to unicast and groupcast. In one novel aspect, CSI report restriction procedures are implemented such that the receiving UE would not receive out of order and/or out of date CSI report.

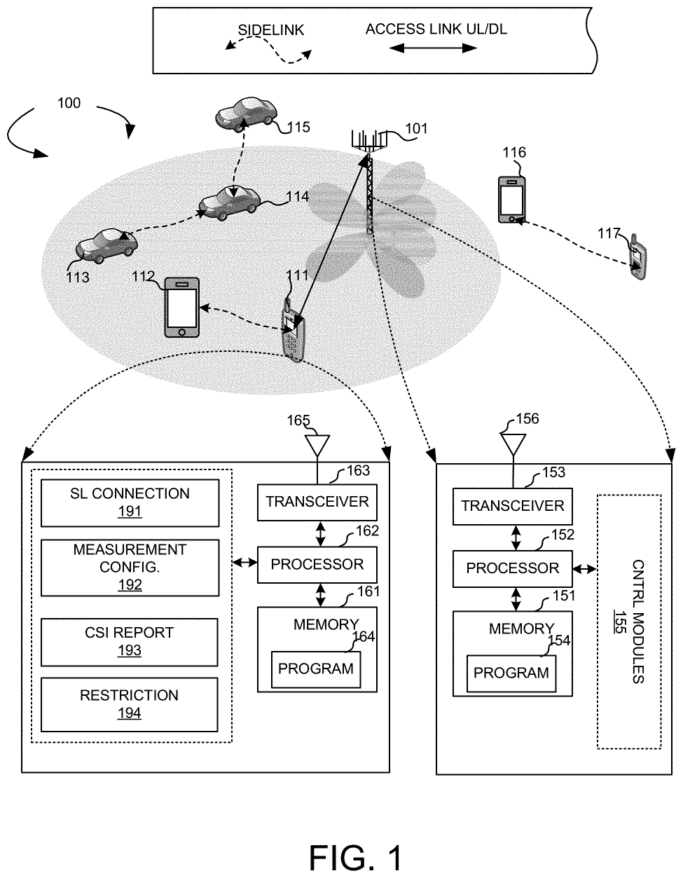

FIG. 1 is a schematic system diagram illustrating an exemplary wireless network for accurate sidelink CSI report with restriction procedure in accordance with embodiments of the current invention. Wireless system 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. The network can be a homogeneous network or heterogeneous network, which can be deployed with the same frequency or different frequency. gNB 101 is an exemplary base station in the NR network.

Wireless network 100 also includes multiple communication devices or mobile stations, such as user equipments (UEs) 111, 112, 113, 114, 115, 116, and 117. The exemplary mobile devices in wireless network 100 have sidelink capabilities. The mobile devices can establish one or more connections with one or more base stations, such as gNB 101. UE 111 has an access link, with uplink (UL) and downlink (DL), with gNB 101. UE 112, which is also served by gNB 101, may also establish UL and DL with gNB 101. UE 111 also establishes a sidelink with UE 112. Both UE 111 and UE 112 are in-coverage devices. Mobile devices on vehicles, such as mobile devices 113, 114, and 115, also have sidelink capabilities. Mobile device 113 and mobile device 114 are covered by gNB 101. Mobile device 113, an in-coverage device, establishes sidelink with mobile device 114, which is also an in-coverage device. Mobile device 115 on a vehicle, however, is an out-of-coverage device. In-coverage mobile device 114 establishes a sidelink with the out-of-coverage device 115. In other embodiments, the mobile devices, such as UE 116 and 117, may both be out-of-coverage but can transmit and receive data packets with another one or more other mobile stations with sidelink connections.

FIG. 1 further illustrates simplified block diagrams of a base station and a mobile device/UE for early packet filtering for UE sidelink relay. gNB 101 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 101. Memory 151 stores program instructions and data 154 to control the operations of gNB 101. gNB 101 also includes a set of control modules 155 that carry out functional tasks to communicate with mobile stations.

UE 111 has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown). A first RF module is used for HF transmitting and receiving, and the other RF module is used for different frequency bands transmitting and receiving, which is different from the HF transceiver. RF transceiver 163 also converts received baseband signals from processor 162, converts them to RF signals, and sends out to antenna 165. Processor 162 processes the received baseband signals and invokes different functional modules to perform features in THE UE. Memory 161 stores program instructions and data 164 to control the operations of THE UE. Antenna 165 sends uplink transmission and receives downlink transmissions to/from antenna 156 of gNB 101.

The UE also includes a set of control modules that carry out functional tasks. These control modules can be implemented by circuits, software, firmware, or a combination of them. A sidelink connection circuit 191 establishes an SL connection with a receiving UE in the wireless network in the wireless network. A measurement circuit 192 performs SL measurements on the sidelink to obtain an SL channel state information (CSI) information including channel quality indicator (CQI) and/or ranking indicator (RI). A CSI report circuit 193 generates a first SL CSI report based on the SL CSI information using a MAC control element (CE), wherein the first SL CSI report is transmitted or retransmitted when a CSI trigger is detected. A restriction circuit 194 performs an SL CSI report restriction process such that the receiving UE receives up-to-date CSI report.

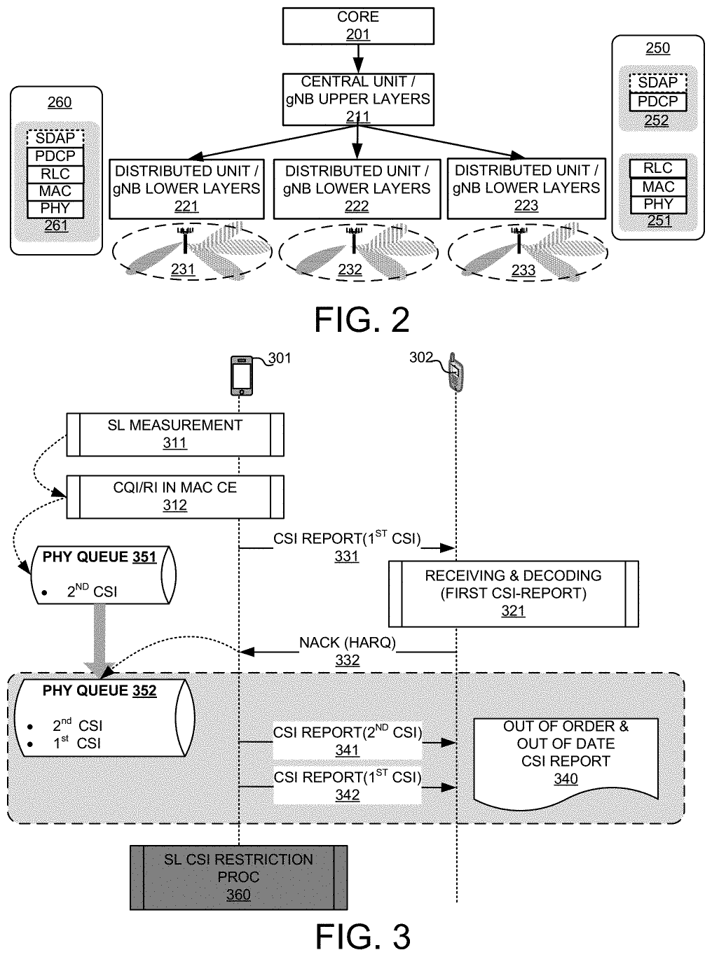

FIG. 2 illustrates an exemplary NR wireless system with centralized upper layers of the NR radio interface stacks in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization and jitter. In one embodiment, SDAP and PDCP layer are located in the CU, while RLC, MAC and PHY layers are located in the DU. A Core unit 201 is connected with one central unit 211 with gNB upper layer 252. In one embodiment 250, gNB upper layer 252 includes the PDCP layer and optionally the SDAP layer. Central unit 211 is connected with distributed units 221, 222, and 221. Distributed units 221, 222, and 223 each correspond to a cell 231, 232, and 233, respectively. The DUs, such as 221, 222 and 223 include gNB lower layers 251. In one embodiment, gNB lower layers 251 include the PHY, MAC and the RLC layers. In another embodiment 260, each gNB has the protocol stacks 261, including SDAP, PDCP, RLC, MAC and PHY layers.

In one novel aspect, the sidelink CSI report restriction procedures are implemented to support accurate CSI report over Sidelink in mobile communication system. The transmitting (TX) UE sets up the restriction of CSI report via initiation of a prohibit timer. If a CSI report is triggered, but the prohibit timer is running, then the CSI report keeps pending and UE does not generate the MAC CE for transmission to Physical layer. The restriction of CSI report is to avoid out of date and/or out of order delivery of CSI report.

FIG. 3 illustrated exemplary diagrams for a UE to perform CSI restriction procedures such that the receiving UE receives latest CSI report in order in accordance with embodiments of the current invention. A transmitting UE 301 establishes sidelink connection with a receiving UE 302. At step 311, UE 301 performs SL measurement. At step 312, UE 301 generates MAC CE that carries SL CSI report with CQI/RI based on the performed measurement. At step 331, UE 301 sends MAC CE carrying the first CSI report to UE 302. At step 321, UE 321 decodes the message carrying the first CSI report if UE 302 receives the message. In one scenario, the message carrying the first CSI report may be lost and UE 302 did not receive it. In other scenarios, UE 302 cannot decode the received message correctly to get the first CSI report. At the same time, UE 301 detects a trigger for the second CSI report. UE 301 generates a new CSI report (the 2^{nd} CSI report) in MAC CE and passes the MAC PDU to the PHY layer queue 351 for transmission. While UE 302 cannot get the first CSI report correctly, a NACK triggering HARQ is sent to UE 301. In other scenarios, the HARQ entity buffers the transmission block carrying the first CSI report message after its initial transmission. And then PHY queue 352 has both the 2^{nd} CSI report and the 1^{st} CSI report for retransmission in its buffer. At step 341, UE 301 sends the 2^{nd} CSI report based on PHY queue 352. Subsequently, at step 342, UE 301 sends the 1^{st} CSI report for retransmission based on HARQ feedback. Scenario 340 described above creates an out-of-order and out-of-date CSI report for the receiving UE 302. In one novel aspect, scenario 340 can be avoided by performing SL CSI report restriction procedure 360. The restriction procedure discussed in the following sections are implemented independently to avoid the problem. In other embodiment, the combination of the individual procedures presented below are used.

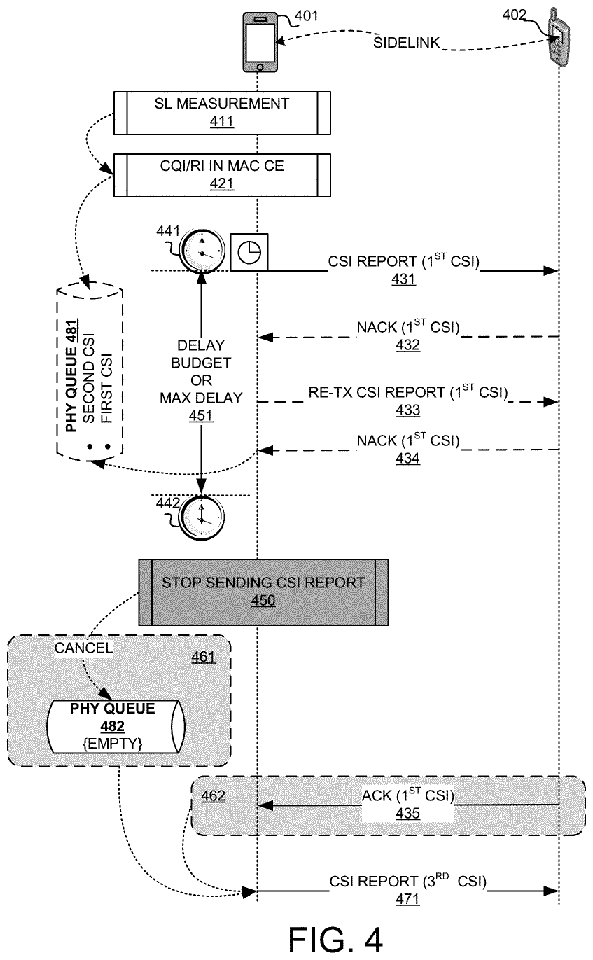

FIG. 4 illustrates exemplary diagrams of a restriction procedure of the TX UE stopping sending SL CSI when the latency of a successful sending of the CSI report is larger than a configured delay budget in accordance with embodiments of the current invention. In one novel aspect, the UE stops sending SL CSI if it is later than the configured delay budget to address the out-of-date issue. A transmitting UE 401 establishes a sidelink connection with a receiving UE 402. At step 411, UE 401 performs sidelink measurement. At step 421, UE 401 generates the first CSI report containing CQI/RI based on the measurement. At step 431, UE 401 sends the CSI report message with the first CSI report to UE 402. At step 451, triggered by the sending the first CSI report, a timer is started to track the latency bound for the transmission of the first CSI report. In some exemplary scenarios, at step 432, UE 402 sends a NACK. At step 433, UE 401 retransmits a CSI report message with the first CSI report. At step 434, UE 402 sends a second NACK. PHY queue 481 may include the first CSI report (and a second CSI report). At step 442, the timer expires. Upon expiration of the latency timer, at step 450, UE 401 stops sending CSI report. In one embodiment, step 450 is triggered by the latency being over a configured delay budget. In another embodiment, step 450 is triggered by the latency being over a maximum delay. UE 401 subsequently cancels pending CSI report in procedure 461. PHY queue 482 is empty without CSI report. Subsequently, UE 401 resumes the CSI report procedure and consequently, a latest generated CSI report is sent to UE 402 in procedure 471. In another embodiment, procedure 462 is used. At step 435, an ACK for the first CSI report is received, and subsequently, the CSI report procedure is resumed.

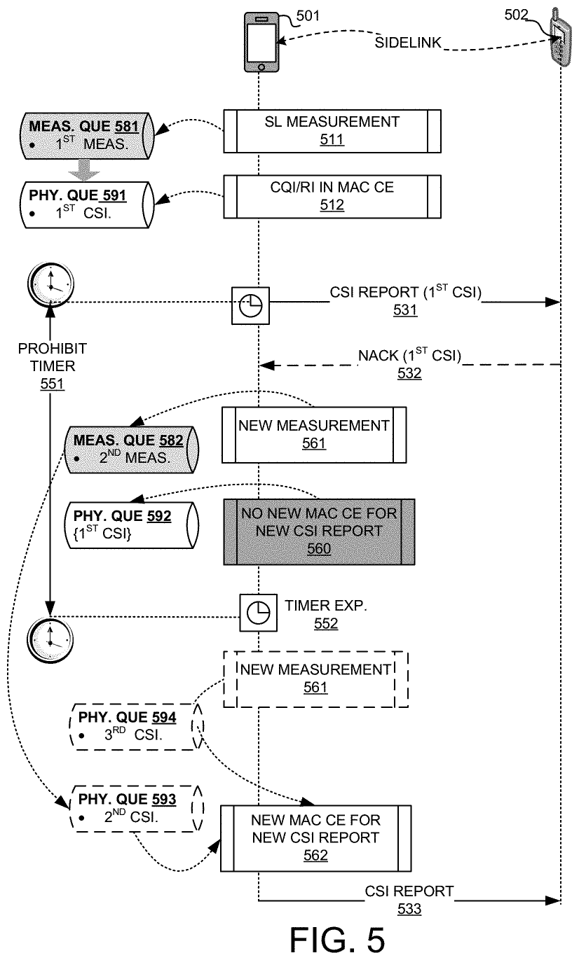

FIG. 5 illustrates exemplary diagrams of a restriction procedure of the TX UE setting a prohibit timer that keeps the CSI report pending without generating MAC CE for transmission in accordance with embodiments of the current invention. In one embodiment, the UE sets up a prohibit timer for CSI report MAC CE transmission. If the prohibit timer is set long enough, we may be able to avoid the problem of out of order delivery of CSI report MAC CE. Of course, the prohibit timer should not be set too long which cause non-instant channel state information. If a CSI report is triggered, but the prohibit timer is running, then the CSI report keeps pending and UE do not generate the MAC CE for transmission. When the prohibit timer expires, UE transmit the MAC CE including the latest information. UE 501 establishes a sidelink connection with UE 502. At step 511, UE 501 performs sidelink measurement. The first measurement is in the measurement queue 581. At step 512, UE 501 generates the first CSI report containing CQI/RI based on the measurement. The MAC CE is delivered to the PHY queue 591 with the first CSI report. At step 531, UE 501 sends the CSI report message with the first CSI report to UE 502. At step 551, a prohibit timer is started. In one exemplary scenario, at step 561, new measurement is triggered with the second measurement in the measurement queue 582. At step 532, UE 502 sends a NACK. At step 560, as the prohibit timer is still running, UE 501 keeps the second CSI report pending and does not generate the MAC CE for transmission. At step 552, the prohibit timer expired. In one scenario, the pending second CSI report is now generated with MAC CE and passed to PHY queue 593. In other scenarios, new measurement is triggered at step 561 after the prohibit timer expires. A third CSI report is generated with MAC CE and passed to the PHY queue 594. At step 562, new message carrying the new CSI report is generated. At step 533, UE 501 sends the new CSI report.

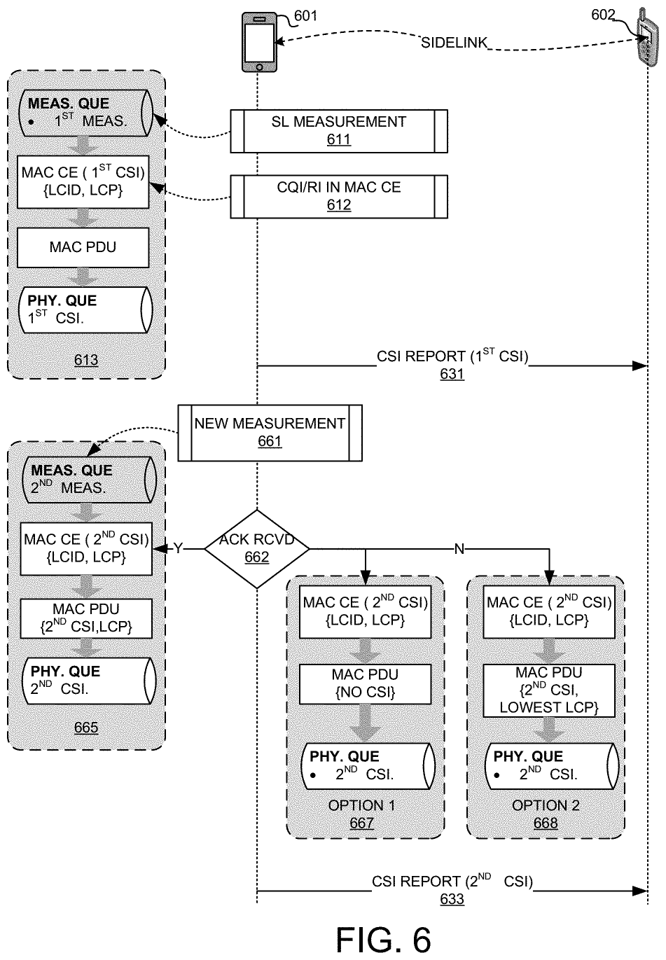

FIG. 6 illustrates exemplary diagrams of a restriction procedure of the TX UE setting a restriction at the MAC layer for packet data unit (PDU) assembly in accordance with embodiments of the current invention. In one embodiment, the UE sets up a restriction at MAC layer for PDU assembly. No new CSI report MAC CE is allowed to be multiplexed and assembled into the MAC PDU if there is no acknowledgement received for the previously CSI report MAC CE (exclusively assembled or non-exclusively assembled). In logic channel priority (LCP), CSI report MAC CE is put lowest priority, which can be controlled by a new timer, to avoid transmitting out of date CSI report. In one embodiment, CSI report MAC CE is prohibited from being multiplexed into a SL MAC PDU if the previous transmission is not yet successful. In another embodiment, CSI report MAC CE is put lowest priority. UE 601 establishes a sidelink connection with UE 602. At step 611, UE 601 performs sidelink measurement. The first measurement is in the measurement queue. UE 601 assembles CSI report in procedure 613. At step 612, UE 601 generates the first CSI report containing CQI/RI based on the measurement. The measurement data is generated for MAC CE to include the first measurement, with a designated LCID and a regular LCP. The MAC CE is delivered to the PHY queue with the first CSI report. At step 631, UE 601 sends the CSI report message with the first CSI report to UE 602. At step 661, new measurement is triggered, and a second CSI report is generated in measurement queue. At step 662, UE 601 checks if the ACK is received for the message carrying the first CSI report. If step 662 determines yes, procedure 665 is performed to pass the second measurement to generate the MAC CE for the second CSI report, passes the MAC PDU with regular LCP to PHY queue with the second CSI report. If step 662 determines no, a MAC layer restriction is performed. In one embodiment, procedure 667 is performed where no MAC PDU is generated for the MAC CE carrying the second CSI report. In another embodiment, procedure 668 is preformed where the MAC PDU carrying the second CSI report is set to have the lowest LCP. A CSI report message carrying the second CSI report is sent to UE 602 at step 633.

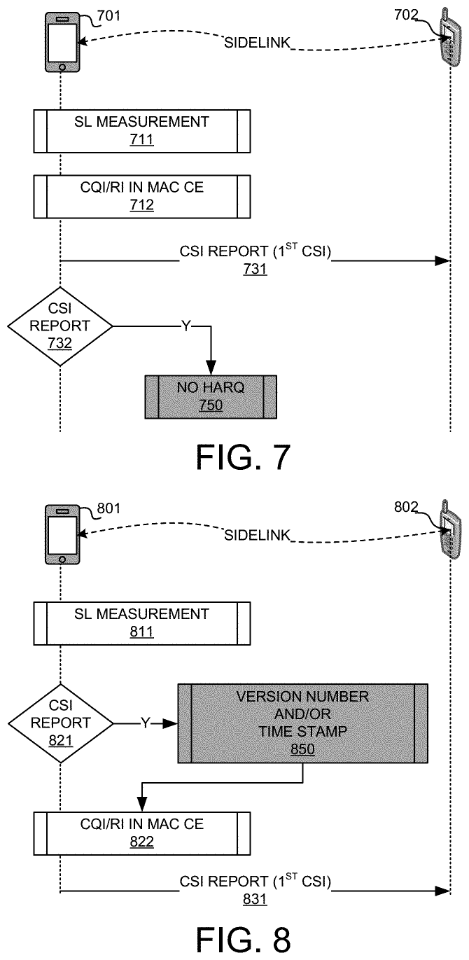

FIG. 7 illustrates exemplary diagrams of a restriction procedure of the TX UE setting a restriction of CSI report for HARQ retransmission in accordance with embodiments of the current invention. In one embodiment, the UE sets up a restriction for retransmission of CSI report MAC CE. No HARQ retransmission is allowed for CSI report MAC CE. A one-shot transmission at PHY together with MAC is performed. The CSI report transmitted, and thus received by the receiving UE, will be sequential and in order. Some CSI report may be lost due to no retransmission. UE 701 establishes a sidelink connection with UE 702. At step 711, UE 701 performs sidelink measurement. At step 712, UE generate CSI report with CQI/RI MAC CE. At step 731, UE 701 sends CSI report message with the first CSI report to UE 702. At step 732, UE 701 determines is a message with HARQ request corresponds to a CSI report MAC CE message. If step 732 determines yes, at step 750, UE 701 prohibits HARQ retransmission of the message carrying the CSI report MAC CE.

FIG. 8 illustrates exemplary diagrams of a restriction procedure of including a version number and/or time stamps for CSI report MAC CE messages in accordance with embodiments of the current invention. Version number/time stamp information can be included in the CSI report MAC CE. The receiving UE has reference of the sequence of the CSI reports. UE 801 establishes a sidelink connection with UE 802. At step 811, UE 801 performs sidelink measurement. At step 812, UE 801 determines if the MAC CE includes a CSI report. If step 821 determines yes, UE 801 adds version number and/or time stamp to the message in step 850. At step 822, UE 801 generates CSI report with CQI/RI MAC CE together with the version number and/or time stamp. At step 831, UE 801 sends CSI report message with the first CSI report to UE 802.

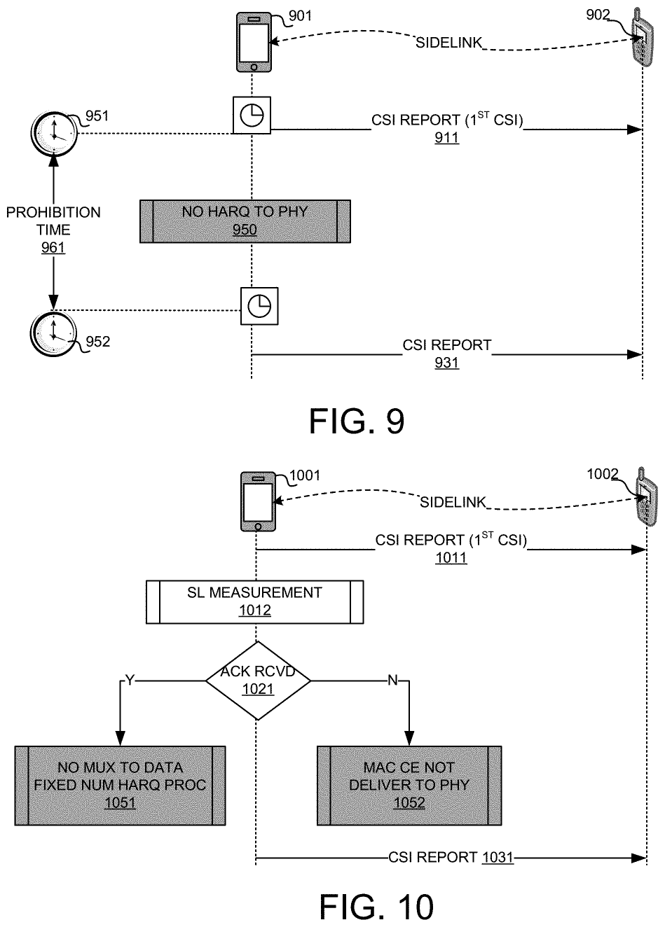

FIG. 9 illustrates exemplary diagrams of a restriction procedure of the TX UE setting prohibit timer with HARQ buffer to prohibit new data being delivered to the PHY layer in accordance with embodiments of the current invention. In one embodiment, the UE sets up a prohibit timer for transmission for data (assembled with a CSI report MAC CE) within HARQ buffer. No new data is delivered from HARQ buffer to PHY before the expiry of the timer. In one embodiment, an accurate value of the duration of the timer is selected to ensure the previous CSI report MAC CE has already correctly transmitted by sender and received by receiver including possible retransmissions. The timer does impact the CSI report assembly at MAC layer. UE 901 establishes a sidelink connection with UE 902. At step 911, UE 901 sends CSI report message with the first CSI report to UE 902. At step 951, a prohibit timer with value 961 is started upon the transmission of the first CSI report. While prohibit timer is running, at step 950, no new data is delivered from HARQ to the PHY. At step 952, prohibit timer expires. At step 931, UE 901 sends a new CSI report to UE 902.

FIG. 10 illustrates exemplary diagrams of a restriction procedure of the TX UE setting TB including only CSI report and no mux with SL data in accordance with embodiments of the current invention. The UE sets up a restriction at HARQ process assignment. The CSI report MAC CE is assembled in an exclusive manner. No multiplexing is allowed between CSI report MAC CE and SL data, nor between CSI report MAC CE and PC5-RRC/S control signaling. The TB includes only the CSI report MAC CE goes to the HARQ buffer of a fixed numbered HARQ process (e.g. 1^{st} HARQ process) sequentially. The new TB going to the HARQ buffer of that HARQ process shall not be delivered to the PHY until the successful transmission of the previous TB. The transmission is successful when there is already received HARQ ACK for the TB. A new timer can be used to avoid too long time spent for the successful transmission of the previously TB. UE 1001 establishes a sidelink connection with UE 1002. At step 1011, UE 1001 sends CSI report message with the first CSI report to UE 1002. At step 1012, a new measurement is triggered. At step 1021, UE 1001 determines if the ACK for the first CSI report sent at step 1011 is received. If step 1021 determines yes, the CSI report MAC CE is assembled in an exclusive manner. At step 1051, no multiplexing is allowed between CSI report MAC CE and SL data, nor between CSI report MAC CE and PC5-RRC/S control signaling. A fixed number of HARQ is assigned. If step 1021 determines no, at step 1052, new TB going to the HARQ buffer of that HARQ process shall not be delivered to the PHY. At step 1031, upon successful receives ACK for the first CSI report, a new CSI report is sent to UE 1002.

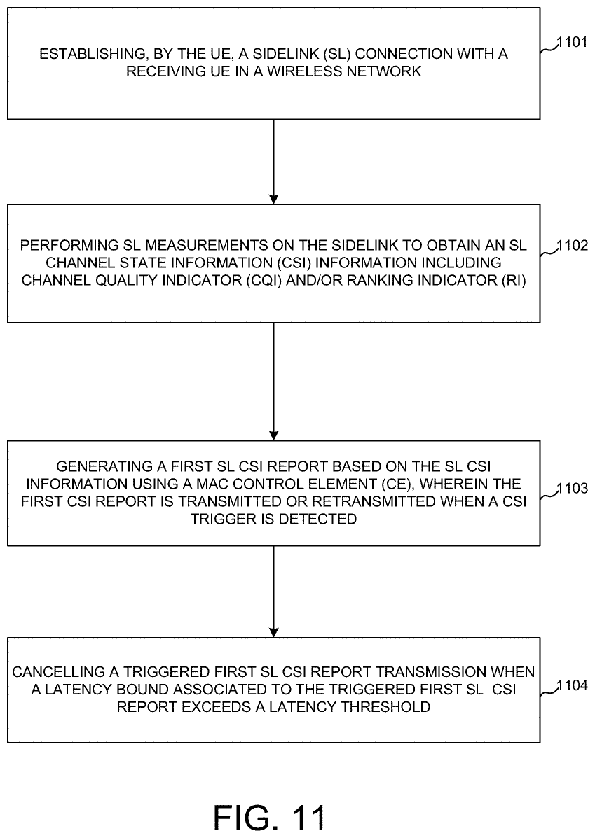

FIG. 11 illustrates an exemplary flow chart of a UE restriction procedure by stopping SL CSI sending when latency is larger than a configured delay budge in accordance with embodiments of the current invention. At step 1101, the UE establishes a sidelink (SL) connection with a receiving UE in a wireless network. At step 1102, the UE performs SL measurements on the sidelink to obtain an SL CSI information including channel quality indicator (CQI) and/or ranking indicator (RI). At step 1102, the UE generates a first SL channel state information (CSI) report based on the SL CSI information using a MAC control element (CE), wherein the first SL CSI report is transmitted or retransmitted when a CSI trigger is detected. At step 1104, the UE cancels a triggered first SL CSI report transmission when a latency bound associated to the triggered first SL CSI report exceeds a latency threshold. The said latency threshold can be a configured delay budget according to the configuration from RRC.

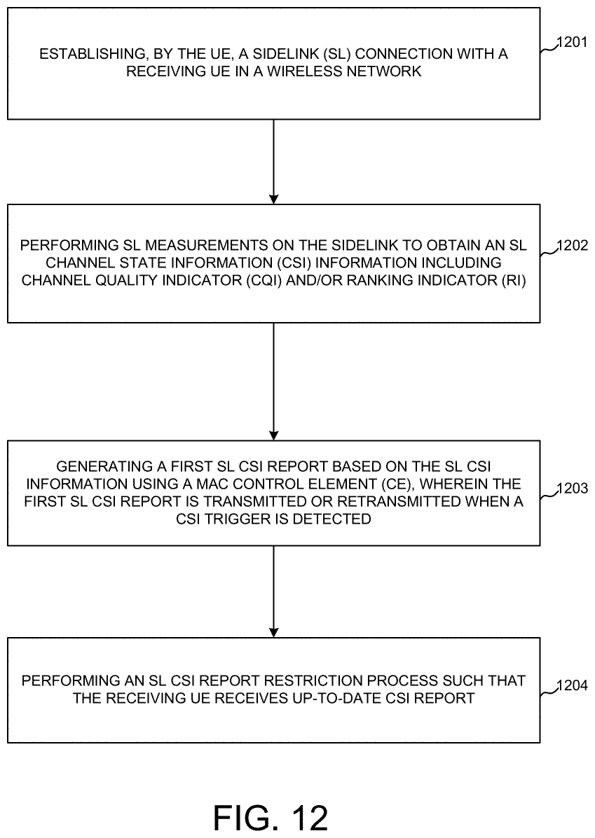

FIG. 12 illustrates an exemplary flow chart of a UE restriction procedure for accurate CSI report for sidelink in accordance with embodiments of the current invention. At step 1201, the UE establishes an SL connection with a receiving UE in a wireless network. At step 1202, the UE performs SL measurements on the sidelink to obtain an SL CSI information including channel quality indicator (CQI) and/or ranking indicator (RI). At step 1203, the UE generates a first SL channel state information (CSI) report based on the SL CSI information using a MAC control element (CE), wherein the first SL CSI report is transmitted or retransmitted when a CSI trigger is detected. At step 1204, the UE performs an SL CSI report restriction process such that the receiving UE receives up-to-date CSI report.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE), comprising:
establishing, by the UE, a sidelink (SL) connection with a receiving UE in a wireless network;
performing SL measurements on the sidelink to obtain an SL channel state information (CSI) information including channel quality indicator (CQI) and/or ranking indicator (RI);
generating a first SL CSI report based on the SL CSI information using a MAC control element (CE), wherein the first CSI report is transmitted or retransmitted when a CSI trigger is detected;
cancelling a triggered first SL CSI report transmission when a latency bound associated to the triggered first SL CSI report exceeds a latency threshold.

2. The method of claim 1, wherein the latency threshold is a configured delay budget.

3. The method of claim 2, wherein the configured delay budget is configured by RRC signaling.

4. The method of claim 1, further comprising: subsequently, transmitting a second SL CSI report with newly measured CSI information upon completion of the first SL CSI report transmission.

5. A method for a user equipment (UE), comprising:
establishing, by the UE, a sidelink (SL) connection with a receiving UE in a wireless network;
performing SL measurements on the sidelink to obtain an SL channel state information (CSI) information including channel quality indicator (CQI) and/or ranking indicator (RI);
generating a first SL CSI report based on the SL CSI information using a MAC control element (CE), wherein the first SL CSI report is transmitted or retransmitted when a CSI trigger is detected;
performing an SL CSI report restriction process such that the receiving UE receives up-to-date CSI report.

6. The method of claim 5, wherein the SL CSI report restriction process involves:
starting a prohibit timer upon transmission of the first SL CSI report; and
prohibiting generating a second SL CSI report on MAC CE before the prohibit timer expires.

7. The method of claim 6, further comprising:
preparing the second SL CSI report on MAC CE based on latest SL CSI information upon expiration of the prohibiting timer; and
transmitting the second SL CSI report to the receiving UE.

8. The method of claim 5, wherein the SL CSI report restriction process involves: prohibiting generating of a second SL CSI report before a success transmission of the first SL CSI report.

9. The method of claim 5, wherein the SL CSI report restriction process involves: prohibiting a hybrid automatically retransmission request (HARQ) for the first SL CSI report.

10. The method of claim 5, wherein the SL CSI report restriction process involves:
starting a prohibit timer upon transmission of the first SL CSI report;
prohibiting new data from being delivered to a PHY layer before the prohibit timer expires.

11. The method of claim 5, wherein the SL CSI report restriction process involves:
assigning a fix numbered HARQ process to the first SL CSI report; and
prohibiting new data from being delivered to a PHY layer in the fix numbered HARQ before an ACK is received corresponding to the first SL CSI report.

12. The method of claim 5, wherein the SL CSI report restriction process involves including in the first SL CSI report at least one reference elements comprising a version number of the first SL CSI report and/or a time stamp of the first SL CSI report.

13. A user equipment (UE), comprising:
a transceiver that transmits and receives radio frequency (RF) signal in a wireless network;
a sidelink (SL) connection circuit that establishes an SL connection with a receiving UE in the wireless network;
a measurement circuit that performs SL measurements on the sidelink to obtain an SL channel state information (CSI) information including channel quality indicator (CQI) and/or ranking indicator (RI);
a CSI report circuit that generates a first SL CSI report based on the SL CSI information using a MAC control element (CE), wherein the first SL CSI report is transmitted or retransmitted when a CSI trigger is detected;
a restriction circuit that performs an SL CSI report restriction process such that the receiving UE receives up-to-date CSI report.

14. The UE of claim 13, wherein the restriction circuit cancels a triggered first SL CSI report transmission when a latency bound associated to the triggered first SL CSI report exceeds a latency threshold.

15. The UE of claim 14, wherein the latency threshold is a configured delay budget.

16. The UE of claim 15, wherein the configured delay budget is configured by RRC signaling.

17. The UE of claim 14, wherein the restriction circuit subsequently, transmits a second SL CSI report with newly measured CQI/RI upon completion of the first CSI report transmission.

18. The UE of claim 13, wherein the restriction circuit starts a prohibit timer upon transmission of the first SL CSI report and prohibits generating a second SL CSI report on MAC CE before the prohibit timer expires.

19. The UE of claim 13, wherein the restriction circuit prohibits generating of a second SL CSI report before a success transmission of the first SL CSI report.

20. The UE of claim 13, wherein the restriction circuit includes at least one reference elements in the first SL CSI report and wherein the reference element comprising a version number of the first SL CSI report and/or a time stamp of the first SL CSI report.
